(19) United States
(12) Patent Application Publication
(10) Pub. No.: US 2022/0200478 A1
(43) Pub. Date: Jun. 23, 2022

(54) HIGH VOLTAGE INVERTER SYSTEM, AND METHOD FOR SYNCHRONIZING SIZE AND PHASE OF HIGH VOLTAGE INVERTER USING SAME

(71) Applicant: LS ELECTRIC CO., LTD., Anyang-si, Gyeonggi-do (KR)

(72) Inventor: Hyun-Seok OH, Anyang-si, Gyeonggi-do (KR)

(21) Appl. No.: 17/602,899

(22) PCT Filed: Mar. 17, 2020
(86) PCT No.: PCT/KR2020/003659

§ 371 Date: Oct. 11, 2021

(30) Foreign Application Priority Data
Apr. 11, 2019 (KR) 10-2019-0042514

(51) Int. Cl. H02M 7/44; H02J 3/08; H02P 27/06

(52) U.S. Cl. CPC H02M 7/44; H02P 27/06; H02J 3/08

(57) ABSTRACT

The present disclosure relates to a high voltage inverter system and a method for synchronizing the size and a phase of a high voltage inverter using same, and particularly to a high voltage inverter system which synchronizes the size and a phase of power output from a high voltage inverter with commercial power during a static transfer, and a method for synchronizing the size and a phase of the high voltage inverter using same. The high voltage inverter system according to the present disclosure synchronizes the size and a phase of voltage output from the high voltage inverter with commercial power, and thus may minimize electric shock during a static transfer from high voltage inverter power to commercial power.

### FIELD

The present disclosure relates to a medium voltage inverter system and a method for synchronizing a voltage level and a phase of a medium voltage inverter using the same. More particularly, the present disclosure relates to a medium voltage inverter system that synchronizes a voltage level and a phase of power output from a medium voltage inverter to those of commercial power in synchronous switching, and a method for synchronizing a voltage level and a phase of a medium voltage inverter using the same.

### DESCRIPTION OF RELATED ART

A medium voltage inverter performs synchronous switching that converts power to be output to a motor from inverter output power to commercial power. However, in general, inverter output power and commercial power have different voltage levels and phases. Therefore, as the inverter output power and the commercial power are not synchronized with each other, an electric shock due to a voltage difference between voltages of the inverter output power and the commercial power is applied to the motor, the inverter, and the commercial power in the switching operation, and in particular, considerable shock is applied to the inverter. In order to solve this problem, conventionally, a phase of the power output from the medium voltage inverter is synchronized with that of the commercial power in the synchronous switching. However, controlling only the phase may allow the voltage difference due to a phase difference to be reduced. However, when the voltage level is set based on a set V/F pattern without separately controlling the voltage level, there are various cases such as unstable voltage depending on an area where the inverter is installed. Thus, occurrence of overcurrent due to the difference between the voltage levels thereof still acts as a risk.

### DISCLOSURE

### Technical Purposes

A purpose of the present disclosure to provide a medium voltage inverter system that may prevent overcurrent as caused by a magnitude-level difference (a voltage-level difference) as well as a phase difference in synchronous switching to prevent damage to a medium voltage inverter, and a method for synchronizing a voltage level and a phase of a medium voltage inverter using the same.

Purposes of the present disclosure are not limited to the above-mentioned purpose. Other purposes and advantages of the present disclosure that are not mentioned above may be understood based on following descriptions, and will be more clearly understood with reference to embodiments of the present disclosure. Further, it will be readily apparent that the purposes and advantages of the present disclosure may be realized using means and combinations thereof indicated in the Claims.

### Technical Solution

One aspect of the present disclosure provides a medium voltage inverter system for synchronously switching power output from a medium voltage inverter to power output from a commercial power supply, wherein the medium voltage inverter system comprises: a phase synchronization controller configured to receive, as feedback information, angle information of the output power output from the medium voltage inverter and synchronize a phase of the output power output from the medium voltage inverter with a phase of input power to the commercial power supply, based on the angle information; and a voltage-level synchronization controller configured to receive, as feedback information, voltage-level information of the output power output from the medium voltage inverter and synchronize a voltage-level of the output power output from the medium voltage inverter with a voltage-level of the input power to the commercial power supply, based on the voltage-level information.

The phase synchronization controller includes: an angle comparing module configured to compare an angel of an inverter angle command with an angle of angle information of input power to generate angle error information as a difference value between the two angles; and a phase synchronization control module configured to synchronizes the angle information of the output power based on the angle error information to generate a synchronized inverter angle command.

The voltage-level synchronization controller includes: a voltage-level comparing module configured to compare a voltage-level of an inverter voltage-level command with a voltage-level of voltage-level information of input power to generate voltage-level error information as a difference value between the two levels; and a voltage-level synchronization control module configured to synchronize the voltage-level information of the output power based on the voltage-level error information to generate a synchronized inverter voltage-level command.

The voltage-level synchronization control module further includes: a maximum voltage calculation module configured to calculate a maximum voltage that the medium voltage inverter can output, based on DC-LINK information of each cell of the medium voltage inverter; and a voltage-level command synchronization module configured to adjust a voltage-level of the synchronized inverter voltage-level command generated by the voltage-level synchronization control module so as not to exceed the maximum voltage calculated by the maximum voltage calculation module.

The system further comprises: a synchronization determination module configured to determine whether each of a voltage-level and a phase of the inverter output power based on the synchronized inverter voltage-level command and the synchronized inverter angle command has been synchronized to be within a predefined range in comparison with each of a voltage-level and a phase of commercial power of the commercial power supply; and an inverter output module configured to: when the synchronization determination module determines that each of the voltage-level and the phase of the inverter output power based on the synchronized inverter voltage-level command and the synchronized inverter angle command has been synchronized to be within the predefined range, receive the synchronized inverter voltage-level command and the synchronized inverter angle command and output power based on the synchronized inverter voltage-level command and the synchronized inverter angle command.

Another aspect of the present disclosure provides a method of synchronizing a voltage level and a phase of a medium voltage inverter for synchronously switching power output from a medium voltage inverter to power output from a commercial power supply, wherein the method comprises: receiving, by a phase synchronization controller, as feedback information, angle information of the output power output from the medium voltage inverter and synchronizing, by the phase synchronization controller, a phase of the output power output from the medium voltage inverter with a phase of input power to the commercial power supply, based on the angle information; and receiving, by a voltage-level synchronization controller, as feedback information, voltage-level information of the output power output from the medium voltage inverter and synchronizing, by a voltage-level synchronization controller, a voltage-level of the output power output from the medium voltage inverter with a voltage-level of the input power to the commercial power supply, based on the voltage-level information.

Receiving, by the phase synchronization controller, the feedback information, the angle information of the output power output from the medium voltage inverter and synchronizing, by the phase synchronization controller, the phase of the output power output from the medium voltage inverter with the phase of the input power to the commercial power supply, based on the angle information include: comparing, by an angle comparing module, an angel of an inverter angle command with an angle of angle information of input power to generate angle error information as a difference value between the two angles; and synchronizing, by a phase synchronization control module, the angle information of the output power based on the angle error information to generate a synchronized inverter angle command.

Receiving, by the voltage-level synchronization controller, as the feedback information, the voltage-level information of the output power output from the medium voltage inverter and synchronizing, by the voltage-level synchronization controller, the voltage-level of the output power output from the medium voltage inverter with the voltage-level of the input power to the commercial power supply, based on the voltage-level information include: comparing, by a voltage-level comparing module, a voltage-level of an inverter voltage-level command with a voltage-level of voltage-level information of input power to generate voltage-level error information as a difference value between the two levels; and synchronizing, by a voltage-level synchronization control module, the voltage-level information of the output power based on the voltage-level error information to generate a synchronized inverter voltage-level command.

Synchronizing, by the voltage-level synchronization control module, the voltage-level information of the output power based on the voltage-level error information to generate the synchronized inverter voltage-level command includes: calculating, by a maximum voltage calculation module, a maximum voltage that the medium voltage inverter can output, based on DC-LINK information of each cell of the medium voltage inverter; and adjusting, by a voltage-level command synchronization module, a voltage-level of the synchronized inverter voltage-level command generated by the voltage-level synchronization control module so as not to exceed the maximum voltage calculated by the maximum voltage calculation module.

The method further comprises: determining, by a synchronization determination module, whether each of a voltage-level and a phase of the inverter output power based on the synchronized inverter voltage-level command and the synchronized inverter angle command has been synchronized to be within a predefined range in comparison with each of a voltage-level and a phase of commercial power of the commercial power supply; and when the synchronization determination module determines that each of the voltage-level and the phase of the inverter output power based on the synchronized inverter voltage-level command and the synchronized inverter angle command has been synchronized to be within the predefined range, receiving, by an inverter output module, the synchronized inverter voltage-level command and the synchronized inverter angle command and outputting, by the inverter output module, power based on the synchronized inverter voltage-level command and the synchronized inverter angle command.

### Technical Effect

The medium voltage inverter system according to the present disclosure may synchronize the voltage-level and the phase of the voltage output from the medium voltage inverter with those of the commercial power to minimize the electric shock in the synchronous switching which converts the power from the medium voltage inverter power to the commercial power.

The above-described effects, and specific effects of the present disclosure as not mentioned above will be described based on specific details for carrying out the disclosure.

### BRIEF DESCRIPTION OF THE DRAWINGS

FIG. 1 is a block diagram of a medium voltage inverter system according to the present disclosure.

FIG. 2 is a block diagram of a medium voltage inverter in a medium voltage inverter system according to the present disclosure.

FIG. 3 and FIG. 4 are graphs for illustrating an operation of a synchronization determination module in the medium voltage inverter system according to the present disclosure.

FIG. 5 is a flowchart of a method for synchronizing a voltage level and a phase of a medium voltage inverter according to the present disclosure.

### DETAILED DESCRIPTIONS

The above objects, features and advantages will be described in detail later with reference to the accompanying drawings. Accordingly, a person with ordinary knowledge in the technical field to which the present disclosure belongs will be able to easily implement the technical idea of the present disclosure. In describing the present disclosure, when it is determined that a detailed description of a known component related to the present disclosure may unnecessarily obscure gist the present disclosure, the detailed description is omitted. Hereinafter, a preferred embodiment according to the present disclosure will be described in detail with reference to the accompanying drawings. In the drawings, the same reference numerals are used to indicate the same or similar elements.

Hereinafter, a medium voltage inverter based on some embodiments of the present disclosure, and a method for synchronizing a voltage level and a phase of a medium voltage inverter system using the medium voltage inverter system will be described.

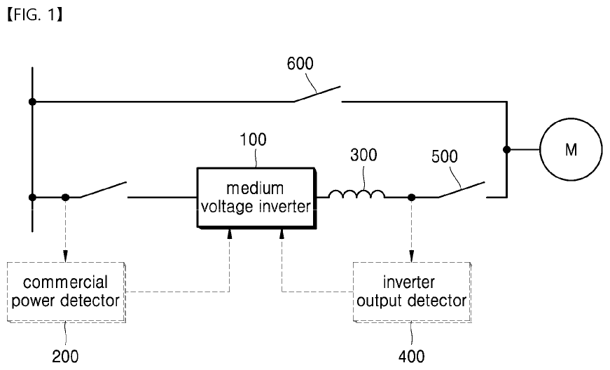

FIG. 1 is a block diagram of a medium voltage inverter system according to the present disclosure.

As shown in FIG. 1, the medium voltage inverter system according to the present disclosure includes a medium voltage inverter 100, a commercial power detector 200 for detecting commercial power to be input to the medium voltage inverter 100, a reactor 300 connected to an output of the medium voltage inverter 100, an inverter output detector 400 that detects power of the medium voltage inverter 100 that is to be output to the motor through the reactor 300, a medium voltage inverter switch 500 that controls the power of the medium voltage inverter 100 that is to be output to the motor through the reactor 300, and a commercial power switch 600 that allows the commercial power to be input to a motor.

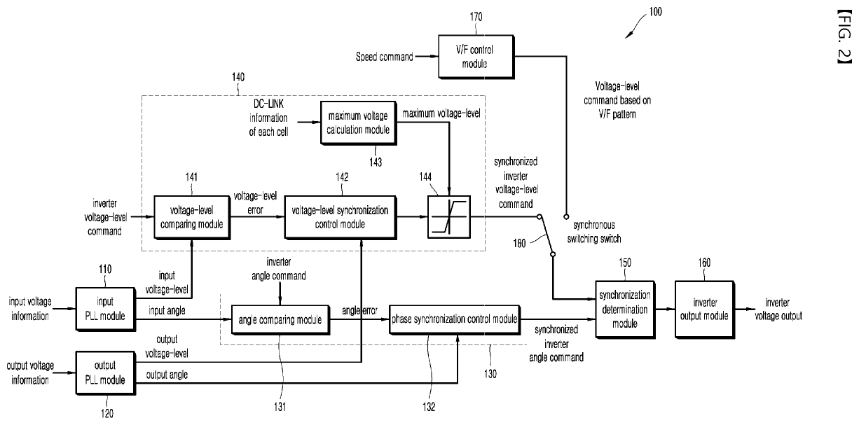

FIG. 2 is a block diagram of the medium voltage inverter in the medium voltage inverter system according to the present disclosure.

As shown in FIG. 2, the medium voltage inverter 100 includes an input PLL (Phase Locked Loop) module which receives input voltage information and determines voltage-level information of input power to the medium voltage inverter 100 and a phase of the input power, an output PLL module 120 that receives output voltage information and determines voltage-level information of output power from the medium voltage inverter 100 and angle information of the output power, a phase synchronization controller 130 that generates an inverter angle command having a synchronized phase based on angle error information and the angle information of the output power, wherein the angle error information is obtained by comparing the angle information of the input power and the inverter angle command, a voltage-level synchronization controller 140 which generates an inverter voltage-level command having a synchronized voltage-level based on voltage-level error information and the voltage-level information of the output power, wherein the voltage-level error information is obtained by comparing the voltage-level information of the input power and the inverter voltage-level command, a synchronization determination module 150 which determines whether the inverter voltage-level command with the synchronized voltage-level is synchronized with a voltage level of the commercial power in the phase synchronized state; and an inverter output module 160 that outputs a synchronized inverter angle command and a synchronized inverter voltage-level command.

The input PLL module 110 receives the input voltage information of the medium voltage inverter 100 as the commercial power from the commercial power detector 200 and determines the voltage-level information of the input power of the medium voltage inverter 100 and the angle information of the input power.

The output PLL module 120 outputs the output voltage from the inverter output power detected by the inverter output power detection module, and feedbacks the voltage-level information of the output power and the phase information of the output power to the phase synchronization control module 132 and the voltage-level synchronization control module 142.

The phase synchronization controller 130 generates the inverter angle command having the synchronized phase. In more detail, the phase synchronization controller 130 generates an inverter angle command having the synchronized phase, based on an inverter angle command, the angle information of the input power output from the input PLL module, and the angle information of the output power output from the output PLL module. For this purpose, the phase synchronization controller 130 further includes an angle comparing module 131 and a phase synchronization control module 132.

The angle comparing module 131 receives the inverter angle command and the angle information of the input power output from the input PLL module and compares the inverter angle command and the angle information of the input power with each other. Further, the angle comparing module 131 transmits, to the phase synchronization control module 132 to be described later, a compared result value, that is, the angle error information which is a difference value between an angle of the angle information of the input power and an angle of the inverter angle command.

The phase synchronization control module 132 performs phase synchronization based on the angle error information transmitted from the angle comparing module 131 and the angle information of the output power output from the output PLL module 120. Further, accordingly, the phase synchronization control module 132 generates the inverter angle command having the synchronized phase based on the angle error information and transmits the generated inverter angle command to the synchronization determination module 150.

The voltage-level synchronization controller 140 generates the synchronized inverter voltage-level command based on the inverter voltage-level command, the voltage-level information of the input power, and the voltage-level information of the output power. To this end, the voltage-level synchronization controller 140 includes a voltage-level comparing module 141 and a voltage-level synchronization control module 142, a maximum voltage calculation module 143, and a voltage-level command synchronization module 144.

The voltage-level comparing module 141 compares the inverter voltage-level command with the voltage-level information of the input power output from the input PLL module to generate the voltage-level error information. In this connection, the voltage-level error information refers to a difference value obtained by comparing the inverter voltage-level command with the voltage-level information of the input power. The generated voltage-level error information is transmitted to the voltage-level synchronization control module 142 to be described later.

The voltage-level synchronization control module 142 generates the inverter voltage-level command with a synchronized voltage-level based on the voltage-level error information generated from voltage-level comparing module 141, and the angle information of the output power output from the output PLL module. The inverter voltage-level command in which the voltage-level generated from the voltage-level synchronization control module 142 is synchronized with a voltage level of the commercial power is referred to as the synchronized inverter voltage-level command. An inverter voltage-level command in which the voltage-level is adjusted so as not to exceed a maximum voltage by the voltage-level command synchronization module 144 to be described later is referred to as a synchronized inverter voltage-level command.

The maximum voltage calculation module 143 calculates the maximum voltage that the medium voltage inverter 100 can output based on DC-LINK information of each cell of the medium voltage inverter 100.

The voltage-level command synchronization module 144 may adjust a voltage-level of the inverter voltage-level command having a first voltage-level generated by the voltage-level synchronization control module 142 and synchronized, based on the maximum voltage calculated by the maximum voltage calculation module 143, thereby generating an inverter voltage-level command having a second voltage-level as synchronized.

The V/F control module 170 generates a voltage-level command based on a V/F pattern so that a ratio of a voltage and a frequency is kept constant based on an input speed command. In this connection, the V/F control module 170 applies power to the motor in a separate manner from application by the phase synchronization controller 130 and the voltage-level synchronization controller 140.

The synchronous switching switch 180 may select one of the voltage-level command based on the V/F pattern output from the V/F control module 170, and the inverter voltage-level command having the synchronized second voltage-level output from the voltage-level command synchronization module 144 and may apply the selected one to the synchronization determination module 150.

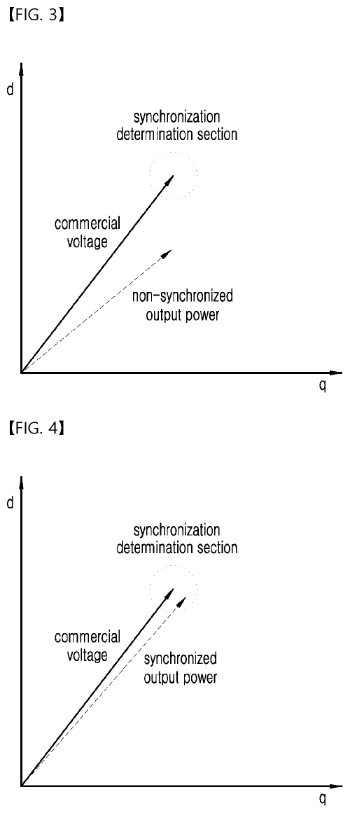

FIG. 3 and FIG. 4 are graphs for illustrating an operation of the synchronization determination module in the medium voltage inverter system according to the present disclosure.

The synchronization determination module 150 determines synchronization based on the inverter angle command having the synchronized phase generated by the phase synchronization control module 132, and the inverter voltage-level command having the synchronized second voltage-level generated by the voltage-level command synchronization module 144. That is, the synchronization determination module 150 may compare the voltage-level of the medium voltage inverter output power with the voltage-level of the commercial power in a state in which the phase of the commercial power and the phase of the medium voltage inverter output power are synchronized with each other, and determining whether the voltage-level of the medium voltage inverter output power is within a predefined range in comparison with the voltage-level of commercial power. As shown in FIG. 3, when the synchronized inverter voltage-level command is not synchronized so as to be within a predefined range of the voltage-level of the commercial power, the synchronization determination module determines that the synchronization is not established. Further, as shown in FIG. 4, when the synchronized inverter voltage-level command is synchronized so as to be within the predefined range of the voltage-level of the commercial power, the synchronization determination module determines that the synchronization has been established

The inverter output module 160 outputs the power when the synchronization determination has been completed by the synchronization determination module 150.

As described above, the medium voltage inverter system according to the present disclosure may synchronize the voltage-level and the phase of the voltage output from the medium voltage inverter with those of the commercial power to minimize the electric shock in the synchronous switching which converts the power from the medium voltage inverter power to the commercial power.

Hereinafter, the disclosure describes a method for synchronizing a voltage level and a phase of an inverter according to the present disclosure with reference to the drawings. Contents redundant to the descriptions of the inverter system according to the present disclosure as described above will be omitted or briefly described.

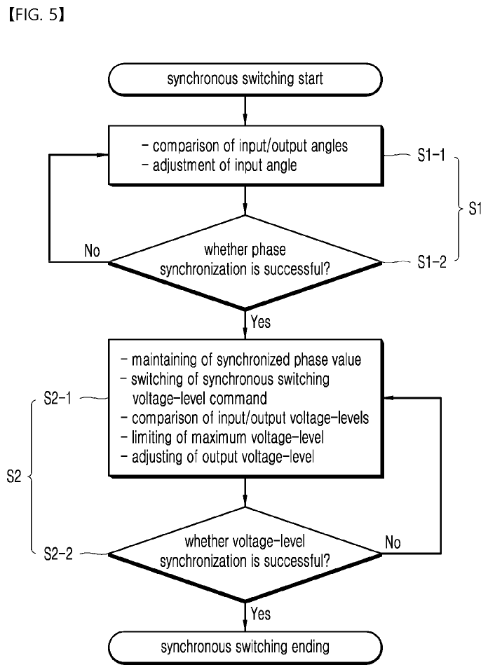

FIG. 5 is a flowchart of a method for synchronizing a voltage level and a phase of a medium voltage inverter according to the present disclosure.

The method for synchronizing the voltage level and the phase of the medium voltage inverter according to the present disclosure includes a step S1 for synchronizing the phase and a step S2 for synchronizing the voltage-level as shown in FIG. 5.

In the step S1 of synchronizing the phase, the phase synchronization controller generates the inverter angle command having the synchronized phase based on the inverter angle command, the angle information of the input power from the input PLL module, and the angle information of the output power from the output PLL module. For this purpose, the step S1 to synchronize the phase includes a step S1-1 to adjust the angle of the output power and a step S1-2 to determine whether the phase synchronization is successful.

In the step S1-1 to adjust the angle of the output power, the angle comparing module receives the inverter angle command and the angle information of the input power output from the input PLL module and compares the angles thereof with each other and generates the angle error information as the difference value between the angle of the inverter angle command and the angle of the angle information of the input power. Further, the phase synchronization control module adjusts the phase of the inverter angle command based on the generated angle error information to synchronize the phase of the inverter angle command with the angle information of the input power.

In the step S1-2 to determine whether the phase synchronization is successful, the synchronization determination module determines whether the phase of the inverter angle command having the phase as synchronized in the step S1-1 for adjusting the angle of the output power is synchronized with the phase of the angle information of the input power. Further, in the step S1-2 for determining whether the phase synchronization is successful, when the phase synchronization is successful, the synchronized phase is maintained. Further, it may be appreciated that when the commercial power is unstable depending on an area, the angle information of the input power may also change unstably. Therefore, it is preferable that the step S1 of synchronizing the phase is continuously performed in a periodic manner.

In the step S2 of synchronizing the voltage-level, the voltage-level synchronization controller generates the synchronized inverter voltage-level command based on the inverter voltage-level command, the voltage-level information of the input power and the voltage-level information of the output power. For this purpose, the step S2 for synchronizing voltage-level includes a step S2-1 for adjusting the voltage-level of the output power and a step S2-2 for determining whether the voltage-level synchronization is successful.

In the step S2-1 to adjust the voltage-level of the output power, the synchronous switching switch to which the voltage-level command based on the V/F pattern is transmitted from the V/F control module is activated in a state in which the synchronized phase in the step S1 to synchronize the phase is maintained, such that the switch switches a synchronous switching voltage-level command. Then, the voltage-level information of the input power is compared with the inverter voltage-level command information to generate the voltage-level error information. Then, the inverter voltage-level command having the first voltage-level as synchronized may be generated based on the generated voltage-level error information and the angle information of the output power output from the output PLL module. Further, the maximum voltage calculation module calculates the maximum voltage that the medium voltage inverter can output, based on the DC-LINK information of each cell of the medium voltage inverter. The voltage-level command synchronization module may adjust the voltage-level based on the calculated maximum voltage so that the voltage-level such that the voltage level of the inverter voltage-level command having the synchronized level does not exceed the calculated maximum voltage.

In the step S2-2 to determine whether the voltage-level synchronization is successful, the synchronization determination module determines whether each of the voltage-level and the phase of the inverter output power based on the inverter voltage-level and angle commands as respectively synchronized in the step S1 to synchronize the phase and the step S2 to synchronize the voltage-level is synchronized to be in within a predefined range in comparison with each of the voltage level and the phase of the commercial power. In this connection, the synchronization determination module performs the synchronous switching to the commercial power when each of the voltage-level and the phase of the inverter output power is synchronized to be within the predefined range compared to each of the level and the phase of the commercial power.

As described above, the present disclosure has been described with reference to the illustrated drawings. However, the present disclosure is not limited to the embodiments and drawings disclosed in the present specification. It is evident that various modifications may be made to the disclosure by those of ordinary skill in the art and within the scope of the technical idea of the present disclosure. In addition, although an effect of a configuration of the present disclosure has not been explicitly described above while illustrating the embodiments of the present disclosure, it is natural that an effect predictable from the configuration should also be appreciated.

1. A medium voltage inverter system for synchronously switching power output from a medium voltage inverter to power output from a commercial power supply, wherein the medium voltage inverter system comprises:
a phase synchronization controller configured to receive, as feedback information, angle information of the output power output from the medium voltage inverter and synchronize a phase of the output power output from the medium voltage inverter with a phase of input power to the commercial power supply, based on the angle information; and
a voltage-level synchronization controller configured to receive, as feedback information, voltage-level information of the output power output from the medium voltage inverter and synchronize a voltage-level of the output power output from the medium voltage inverter with a voltage-level of the input power to the commercial power supply, based on the voltage-level information.

2. The medium voltage inverter system of claim 1, wherein the phase synchronization controller includes:
an angle comparing module configured to compare an angel of an inverter angle command with an angle of angle information of input power to generate angle error information as a difference value between the two angles; and
a phase synchronization control module configured to synchronizes the angle information of the output power based on the angle error information to generate a synchronized inverter angle command.

3. The medium voltage inverter system of claim 2, wherein the voltage-level synchronization controller includes:
a voltage-level comparing module configured to compare a voltage-level of an inverter voltage-level command with a voltage-level of voltage-level information of input power to generate voltage-level error information as a difference value between the two levels; and
a voltage-level synchronization control module configured to synchronize the voltage-level information of the output power based on the voltage-level error information to generate a synchronized inverter voltage-level command.

4. The medium voltage inverter system of claim 3, wherein the voltage-level synchronization control module further includes:
a maximum voltage calculation module configured to calculate a maximum voltage that the medium voltage inverter can output, based on DC-LINK information of each cell of the medium voltage inverter; and
a voltage-level command synchronization module configured to adjust a voltage-level of the synchronized inverter voltage-level command generated by the voltage-level synchronization control module so as not to exceed the maximum voltage calculated by the maximum voltage calculation module.

5. The medium voltage inverter system of claim 4, wherein the system further comprises:
a synchronization determination module configured to determine whether each of a voltage-level and a phase of the inverter output power based on the synchronized inverter voltage-level command and the synchronized inverter angle command has been synchronized to be within a predefined range in comparison with each of a voltage-level and a phase of commercial power of the commercial power supply; and
an inverter output module configured to: when the synchronization determination module determines that each of the voltage-level and the phase of the inverter output power based on the synchronized inverter voltage-level command and the synchronized inverter angle command has been synchronized to be within the predefined range, receive the synchronized inverter voltage-level command and the synchronized inverter angle command and output power based on the synchronized inverter voltage-level command and the synchronized inverter angle command.

6. A method of synchronizing a voltage level and a phase of a medium voltage inverter for synchronously switching power output from a medium voltage inverter to power output from a commercial power supply, wherein the method comprises:
receiving, by a phase synchronization controller, as feedback information, angle information of the output power output from the medium voltage inverter and synchronizing, by the phase synchronization controller, a phase of the output power output from the medium voltage inverter with a phase of input power to the commercial power supply, based on the angle information; and
receiving, by a voltage-level synchronization controller, as feedback information, voltage-level information of the output power output from the medium voltage inverter and synchronizing, by a voltage-level synchronization controller, a voltage-level of the output power output from the medium voltage inverter with a voltage-level of the input power to the commercial power supply, based on the voltage-level information.

7. The method of claim 6, wherein receiving, by the phase synchronization controller, the feedback information, the angle information of the output power output from the medium voltage inverter and synchronizing, by the phase synchronization controller, the phase of the output power output from the medium voltage inverter with the phase of the input power to the commercial power supply, based on the angle information include:
comparing, by an angle comparing module, an angel of an inverter angle command with an angle of angle information of input power to generate angle error information as a difference value between the two angles; and
synchronizing, by a phase synchronization control module, the angle information of the output power based on the angle error information to generate a synchronized inverter angle command.

8. The method of claim 7, wherein receiving, by the voltage-level synchronization controller, as the feedback information, the voltage-level information of the output power output from the medium voltage inverter and synchronizing, by the voltage-level synchronization controller, the voltage-level of the output power output from the medium voltage inverter with the voltage-level of the input power to the commercial power supply, based on the voltage-level information include:
comparing, by a voltage-level comparing module, a voltage-level of an inverter voltage-level command with a voltage-level of voltage-level information of input power to generate voltage-level error information as a difference value between the two levels; and
synchronizing, by a voltage-level synchronization control module, the voltage-level information of the output power based on the voltage-level error information to generate a synchronized inverter voltage-level command.

9. The method of claim 8, wherein synchronizing, by the voltage-level synchronization control module, the voltage-level information of the output power based on the voltage-level error information to generate the synchronized inverter voltage-level command includes:
calculating, by a maximum voltage calculation module, a maximum voltage that the medium voltage inverter can output, based on DC-LINK information of each cell of the medium voltage inverter; and
adjusting, by a voltage-level command synchronization module, a voltage-level of the synchronized inverter voltage-level command generated by the voltage-level synchronization control module so as not to exceed the maximum voltage calculated by the maximum voltage calculation module.

10. The method of claim 9, wherein the method further comprises:
determining, by a synchronization determination module, whether each of a voltage-level and a phase of the inverter output power based on the synchronized inverter voltage-level command and the synchronized inverter angle command has been synchronized to be within a predefined range in comparison with each of a voltage-level and a phase of commercial power of the commercial power supply; and
when the synchronization determination module determines that each of the voltage-level and the phase of the inverter output power based on the synchronized inverter voltage-level command and the synchronized inverter angle command has been synchronized to be within the predefined range, receiving, by an inverter output module, the synchronized inverter voltage-level command and the synchronized inverter angle command and outputting, by the inverter output module, power based on the synchronized inverter voltage-level command and the synchronized inverter angle command.
